(19) United States
(12) Patent Application Publication
(10) Pub. No.: US 2018/0041020 A1
(43) Pub. Date: Feb. 8, 2018

(54) SEAL STRUCTURE FOR MULTIPLE-CORE CABLE

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Hirokazu KOMORI, Yokkaichi, Mie (JP); Tomoyuki SAKATA, Yokkaichi, Mie (JP); Makoto HIGASHIKOZONO, Yokkaichi, Mie (JP)

(21) Appl. No.: 15/552,643

(22) PCT Filed: Mar. 7, 2016
(86) PCT No.: PCT/JP2016/056926

§ 371 Date: Aug. 22, 2017

(30) Foreign Application Priority Data
Mar. 11, 2015 (JP) 2015-048398

(51) Int. Cl. H02G 15/04; H01B 7/18; H02G 3/32; H01B 7/282

(52) U.S. Cl. CPC H02G 15/046; H01B 7/282; H01B 7/18; H02G 3/32

(57) ABSTRACT

A multiple-core cable in which a plurality of electrical wires are enveloped by a sheath, and the plurality of electrical wires extend out from a terminal of the sheath; a rubber plug provided with a sheath covering portion that is fitted around the terminal of the sheath, and an electrical wire through-hole portion that has a plurality of through-holes through which the electrical wires respectively pass; and clamping rings that are attached to the sheath covering portion and the electrical wire through-hole portion of the rubber plug and can clamp the sheath covering portion and the electrical wire through-hole portion from the outer circumferential side.

### CROSS REFERENCE TO RELATED APPLICATIONS

This application claims the priority of Japanese patent application JP2015-048398 filed on Mar. 11, 2015, the entire contents of which are incorporated herein.

### Technical Field

The technology disclosed in this specification relates to a seal structure for a multiple-core cable.

### Background Art

A multiple-core cable has a structure in which a plurality of electrical wires are covered by a sheath that is made of an insulating resin material, and, conventionally, a seal structure (water stop structure) for the terminal portion of a multiple-core cable is disclosed in JP 2012-182924A (referred to as Patent Document 1 hereinafter). In this seal structure, terminal processing is performed on the multiple-core cable to branch off each electrical wire from the terminal of the sheath, a hot-melt block that includes partition walls for partitioning the electrical wires from each other is attached to the branched-off electrical wires, and then a heat-shrink tube is placed over the group of electrical wires so as to surround the terminal of the sheath. Thereafter, heat processing is performed to melt the hot-melt block and fill the gaps between the electrical wires so as to waterproof the spaces between the electrical wires, and then the heat-shrink tube is heated so as to shrink, thus preventing the intrusion of water from the group of electrical wires into the terminal of the sheath.

### SUMMARY

With this conventional seal structure, the process of heating and melting the hot-melt resin and then allowing cooling and hardening in particular is time-consuming, and therefore it cannot necessarily be said that this seal structure is satisfactory when taking operation efficiency into account.

The technology disclosed in this specification was achieved in light of the above-described situation.

A seal structure for a multiple-core cable disclosed by this specification includes: a multiple-core cable in which a plurality of electrical wires are enveloped by a sheath, and the plurality of electrical wires extend out from a terminal of the sheath; a rubber plug provided with a sheath covering portion that is fitted around the terminal of the sheath, and an electrical wire through-hole portion that has a plurality of through-holes through which the electrical wires respectively pass; and a clamping member that is attached to the sheath covering portion and the electrical wire through-hole portion of the rubber plug and can clamp the sheath covering portion and the electrical wire through-hole portion from an outer circumferential side.

The sheath covering portion provided in the rubber plug is fitted around the terminal of the sheath of the multiple-core cable, and the electrical wires that extend out from the terminal of the sheath are inserted into the through-holes of the electrical wire through-hole portion provided in the same rubber plug, and thereafter the sheath covering portion and the electrical wire through-hole portion are clamped by the clamping member from the outer circumferential side. Accordingly, the inner peripheral surface of the sheath covering portion is in close contact with the outer peripheral surface of the terminal of the sheath with a predetermined contact pressure over the entire circumference, and the inner peripheral surfaces of the through-holes of the electrical wire through-hole portion are in close contact with the outer peripheral surfaces of the electrical wires with a predetermined contact pressure over the entire circumference, consequently sealing the terminal of the sheath as well as the regions surrounding the electrical wires. By employing an assembly format that uses the rubber plug and the clamping member, it is possible to construct the seal structure in a shorter time, thus making it is possible to reduce manufacturing cost, and by including the clamping member in particular, it is possible to ensure reliable seal functionality.

Configurations such as the following are also possible.

The clamping member has a sheath covering portion clamping member that is attached to the sheath covering portion, and an electrical wire through-hole portion clamping member that is attached to the electrical wire through-hole portion, and the sheath covering portion clamping member and the electrical wire through-hole portion clamping member are provided integrally. Accordingly, the number of components is reduced, and the clamping member attachment operation is also simplified.

The clamping member is provided on a bracket for attachment to a vehicle. The seal structure is constructed with use of the bracket that specifies the attachment position of the terminal portion of the multiple-core cable, thus making it possible to achieve a more neatly organized multiple-core cable routing structure.

The clamping member is formed by a C-shaped clamping ring that includes an insertion groove extending along the axial direction and that is capable of elastic deformation in a diameter direction.

The clamping ring can be fitted around the sheath covering portion and the electrical wire through-hole portion while inserting the sheath covering portion and the electrical wire through-hole portion into the clamping ring in the diameter direction through the insertion groove. The clamping member attachment operation is simplified.

According to the technology disclosed by this specification, an assembly format is achieved for the seal structure, thereby making it possible to construct the seal structure in a shorter time, and thus making it is possible to reduce manufacturing cost, while also making it possible to ensure reliable seal functionality.

### BRIEF DESCRIPTION OF DRAWINGS

FIG. 1 is a perspective view of the structure of a seal portion according to an embodiment.

FIG. 2 is a front view of the structure of the seal portion.

FIG. 3 is a side view of the structure of the seal portion.

FIG. 4 is a cross-sectional view taken along line IV-IV in FIG. 2.

FIG. 5 is a cross-sectional view taken along line V-V in FIG. 2.

FIG. 6 is a cross-sectional view taken along line VI-VI in FIG. 2.

FIG. 7 is a cross-sectional view taken along line VII-VII in FIG. 3.

### DESCRIPTION OF EMBODIMENTS

### Embodiment

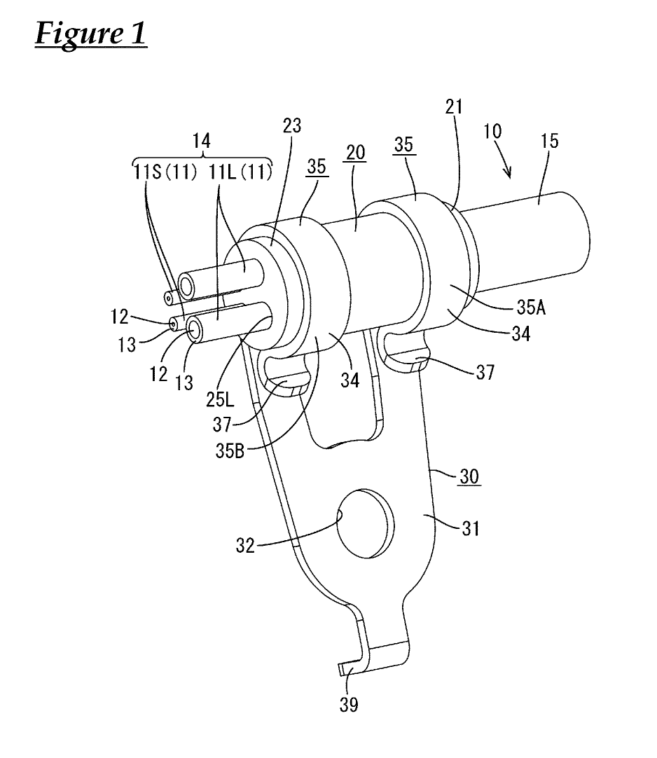

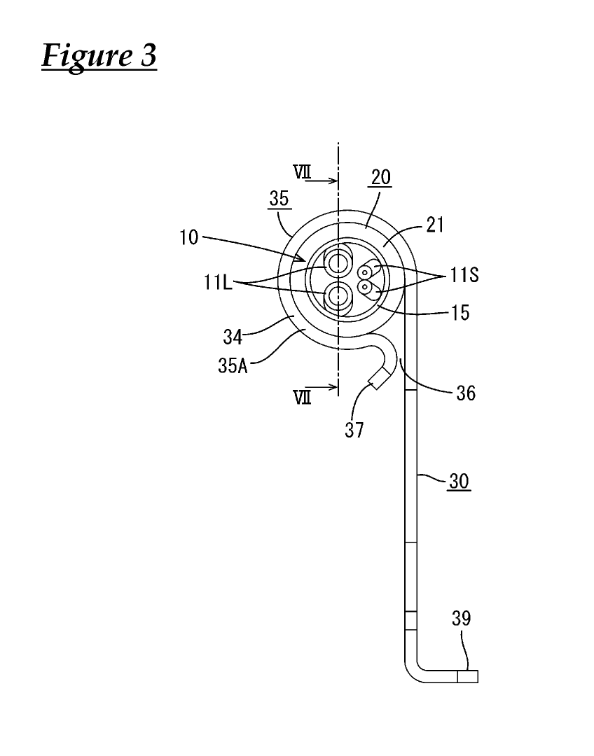

An embodiment will be described below with reference to FIGS. 1 to 7. In the present embodiment, a four-core cable is given as an example of a multiple-core cable 10, and application as, for example, a wire harness for an electrical parking brake installed in a vehicle is possible.

As shown in FIG. 1, a seal structure is constructed by attaching a rubber plug 20 to a terminal portion of the multiple-core cable 10, and attaching the rubber plug 20 to a bracket 30 for attachment to a predetermined position in a vehicle.

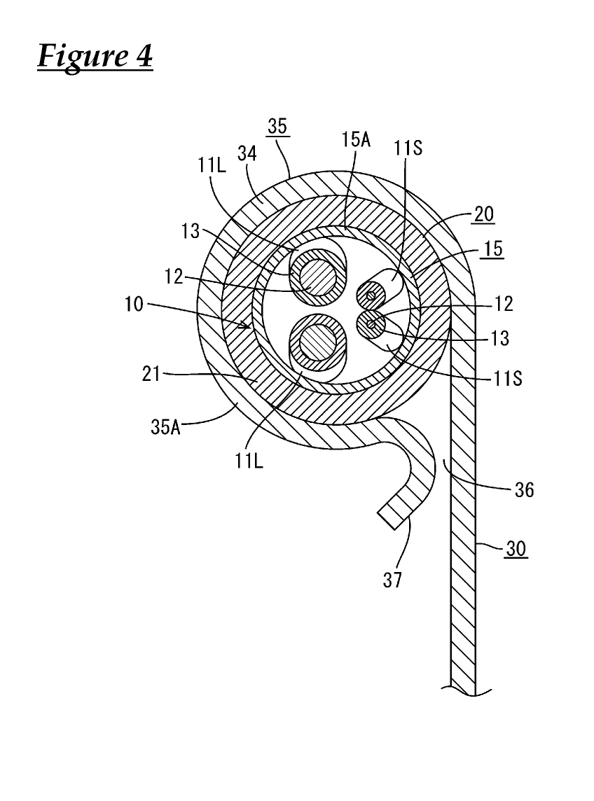

The multiple-core cable 10 is a four-core round cable as described above, and has a structure in which four electrical wires 11 (referred to as a group of electrical wires 14 when appropriate) are enveloped by a sheath 15 that is made of an insulating resin. The electrical wires 11 are each a sheathed electrical wire (see FIG. 4) constituted by a metal core wire 12 that is covered by an insulating covering 13 made of a synthetic resin, and the electrical wires 11 include two each of two types of electrical wires 11L and 11S that have different outer diameters. The two first electrical wires 11L that have a larger diameter function as connection wires for connection to a motor for an electrical parking brake, and the two second electrical wires 11S that have a smaller diameter function as signal lines for sensors in an anti-lock brake system.

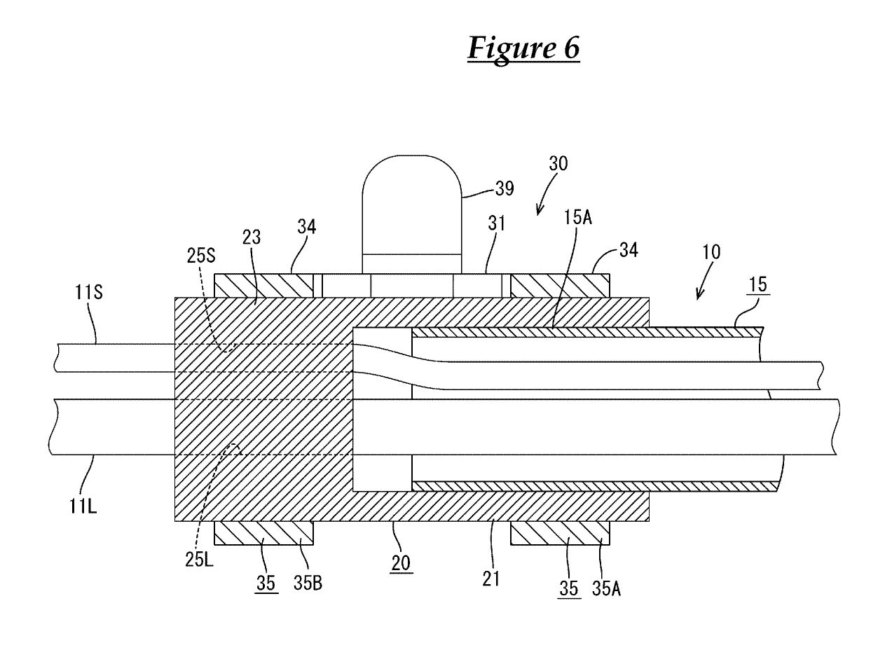

The terminal portion of the multiple-core cable 10 is subjected to predetermined terminal processing such as stripping so as to have a structure in which the four electrical wires 11L and 11S are lead out and branched off from a terminal 15A (see FIG. 6) of the sheath 15, and the rubber plug 20 is attached to the terminal portion of the multiple-core cable 10 having this structure.

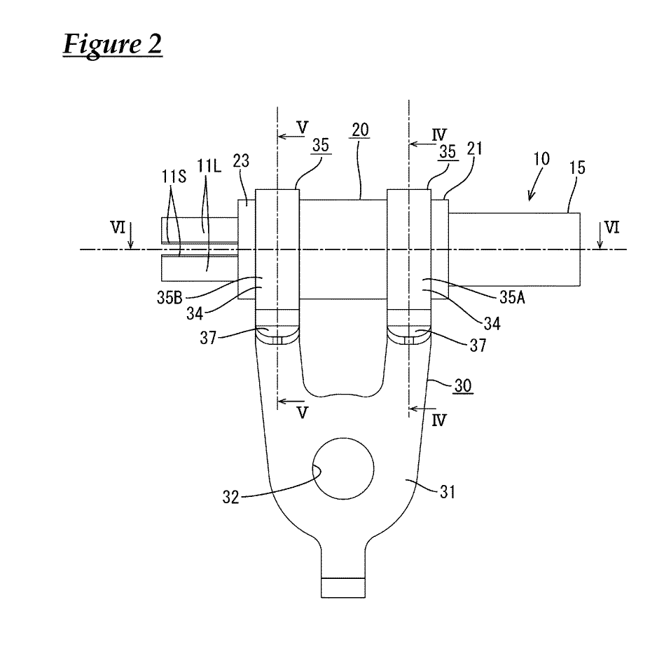

As shown in FIGS. 2, 6, and 7, the rubber plug 20 is shaped as a horizontally elongated circular column having an outer diameter dimension that is a predetermined amount larger than the multiple-core cable 10.

A sheath covering portion 21, which is shaped as a cylinder that is open at the rear face, is formed in a region having a predetermined length (approximately ⅔ of the total length) in the rear portion side (right side in FIG. 6) of the rubber plug 20, and this sheath covering portion 21 can be substantially tightly fitted around the terminal 15A of the sheath 15.

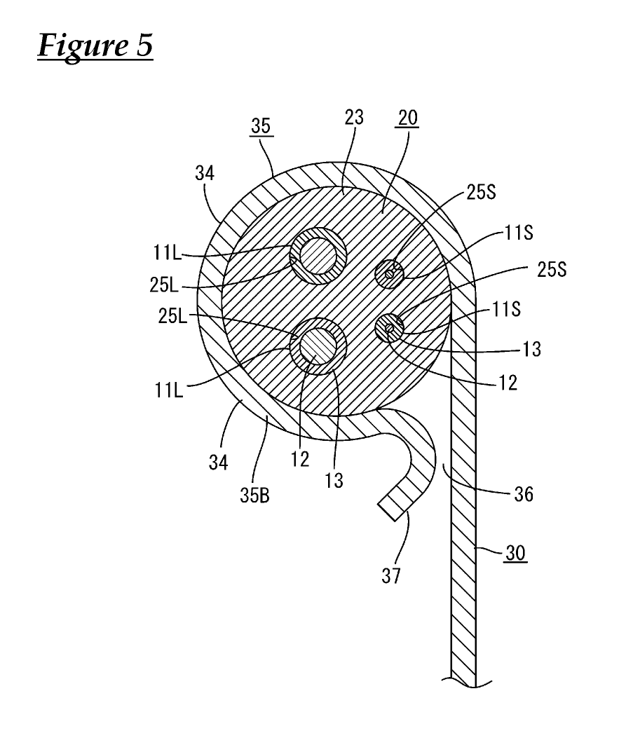

A solid electrical wire through-hole portion 23 is formed in the remaining front end portion of the rubber plug 20. As shown in FIGS. 5 to 7, two first through-holes 25L and two second through-holes 25S, through which the larger-diameter first electrical wires 11L and the smaller-diameter second electrical wires 11S substantially tightly pass individually, are formed in the electrical wire through-hole portion 23.

Regarding the formation locations of the first through-holes 25L and the second through-holes 25S, as shown in FIG. 5, the two first through-holes 25L are formed vertically side-by-side with a predetermined gap therebetween in a region approximately on one side of the center line (vertical line) in the diameter direction of the electrical wire through-hole portion 23, and the two second through-holes 25S are formed vertically side-by-side with a predetermined gap therebetween on the other side.

Also, a bracket 30 is provided in order for the terminal portion of the multiple-core cable 10, which is provided with the seal structure, to be attached to a predetermined location in a vehicle. This bracket 30 is formed with the shape shown in FIGS. 1 to 3 by performing press processing on a metal plate that has elasticity, such as a spring steel plate.

The bracket 30 includes an attachment base plate 31 in which an attachment hole 32 (bolt insertion hole) is formed, and two clamping rings 35 (one example of a clamping member) are formed so as to protrude in a forked manner from a peripheral edge on the leading end side (upper end) of the attachment base plate 31.

The clamping rings 35 include a sheath covering portion clamping ring 35A that is attached to the sheath covering portion 21, and an electrical wire through-hole portion clamping ring 35B that is attached to the electrical wire through-hole portion 23. The clamping rings 35 are constituted by belt-like pieces 34 that extend parallel to each other from the upper end of the attachment base plate 31, and the leading ends of the belt-like pieces 34 are bent over toward the base end side so as to form a C-shaped cross-section that has a diameter dimension somewhat smaller than the outer diameter of the rubber plug 20. An insertion groove 36 that extends in the axial direction is formed between the base end and the bent-over leading ends of the belt-like pieces 34 so as to allow insertion of the rubber plug 20 (sheath covering portion 21 and electrical wire through-hole portion 23) in the diameter direction. A guide portion 37 that extends in a diagonally outward direction is formed at the leading end of each of the clamping rings 35 (belt-like pieces 34).

In other words, the bracket 30 is shaped such that the two clamping rings 35 having the same above-described shape protrude in a forked manner from a peripheral edge (upper edge) of the attachment base plate 31 with a predetermined gap therebetween on the same axis. Note that a rotation stop piece 39, which is L-shaped and is for preventing rotation, is formed on a peripheral edge (lower edge) on the side of the attachment base plate 31 that is opposite to the side where the clamping rings 35 are provided.

Next, an example of an assembly procedure according to the present embodiment will be described.

First, terminal processing is performed on the multiple-core cable 10, that is to say a predetermined length of the sheath 15 is stripped such that the four electrical wires 11L and 11S are lead out from the terminal 15A of the remaining sheath 15 in an appropriately separated state.

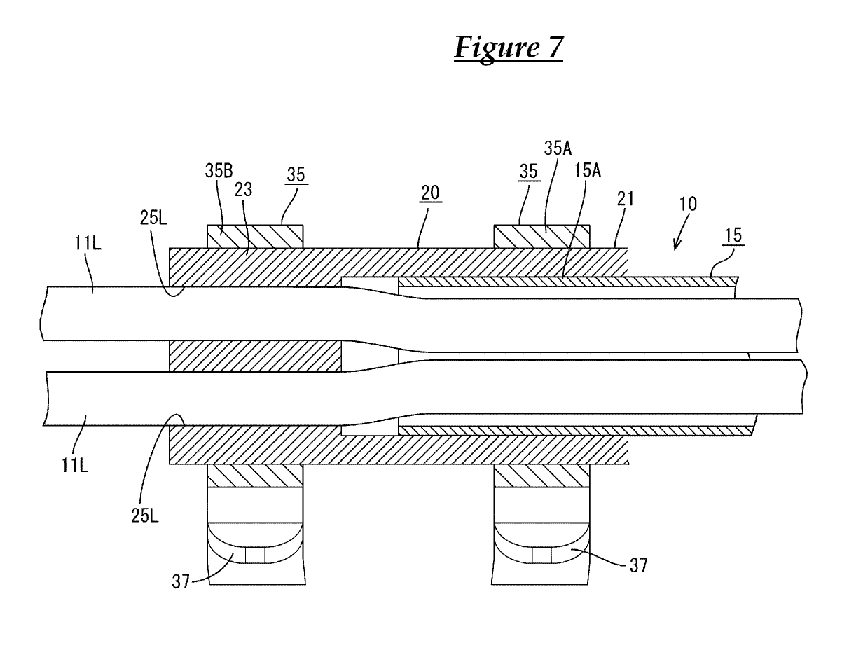

In this state, the terminals of the first electrical wires 11L and the second electrical wires 11S are placed inside the sheath covering portion 21 of the rubber plug 20 from the rear, then inserted into the corresponding first through-holes 25L and second through-holes 25S formed in the electrical wire through-hole portion 23, and pushed forward from the front surface of the electrical wire through-hole portion 23. Subsequently, the terminal 15A of the sheath 15 is inserted into the sheath covering portion 21 while pulling the protruding electrical wires 11L and 11S forward. As shown in FIGS. 6 and 7, when the terminal 15A of the sheath 15 reaches the vicinity of the deep-side surface of the sheath covering portion 21, the pulling of the electrical wires 11L and 11S and the pushing of the terminal 15A of the sheath 15 is stopped. This thus obtains a state in which the rubber plug 20 is attached to the terminal portion of the multiple-core cable 10.

Subsequently, the rubber plug 20, which is attached to the terminal portion of the multiple-core cable 10 as described above, is attached to the bracket 30. Specifically, the rubber plug 20 is brought into contact with the attachment base plate 31 of the bracket 30 and then pressed toward the two front and rear clamping rings 35. When the portion of the rubber plug 20 located toward the rear end side of the sheath covering portion 21, and the electrical wire through-hole portion 23 come into contact with the guide portions 37 of the corresponding clamping rings 35, and are then further pressed, they cause the clamping rings 35 to elastically increase in diameter so as to open the insertion groove 36, and are pushed inside.

When these portions are pushed farther and pass through the insertion groove 36, as shown in FIGS. 4 and 5, the clamping rings 35 decrease in diameter due to elastic restoration force, and the portion of the sheath covering portion 21 toward the rear end and the electrical wire through-hole portion 23 are clamped by the corresponding clamping rings 35 from the outer circumferential side over substantially the entire circumference. Accordingly, the inner peripheral surface of the sheath covering portion 21 is in close contact with the outer peripheral surface of the terminal 15A of the sheath 15 with a predetermined contact pressure over the entire circumference, and the inner peripheral surfaces of the through-holes 25L and 25S of the electrical wire through-hole portion 23 are in close contact with the outer peripheral surfaces of the electrical wires 11L and 11S with a predetermined contact pressure over the entire circumference, consequently sealing the terminal 15A of the sheath 15 as well as the regions surrounding the electrical wires 11L and 11S.

The bracket 30 with the rubber plug 20 attached thereto in this way is arranged at a set attachment location in the vehicle and fixed by screwing a bolt (not shown) through the attachment hole 32. Accordingly, the terminal portion of the multiple-core cable 10 with the constructed seal structure is attached at a predetermined attachment location set in the vehicle.

Actions and effects such as the following can be obtained with the present embodiment. The sheath covering portion 21 of the rubber plug 20 is fitted around the terminal 15A of the sheath 15 of the multiple-core cable 10, the electrical wires 11L and 11S extending from the terminal 15A of the sheath 15 are inserted through the through-holes 25L and 25S of the electrical wire through-hole portion 23 of the rubber plug 20, and thereafter the sheath covering portion 21 and the electrical wire through-hole portion 23 are clamped from the outer circumferential side by the clamping rings 35 provided on the bracket 30. Accordingly, the inner peripheral surface of the sheath covering portion 21 is in close contact with the outer peripheral surface of the terminal 15A of the sheath 15 with a predetermined contact pressure over the entire circumference, and the inner peripheral surfaces of the through-holes 25L and 25S of the electrical wire through-hole portion 23 are in close contact with the outer peripheral surfaces of the electrical wires 11L and 11S with a predetermined contact pressure over the entire circumference, consequently sealing the terminal 15A of the sheath 15 as well as the regions surrounding the electrical wires 11L and Ss.

By employing this assembly format that uses the rubber plug 20 and the clamping rings 35, the seal structure can be constructed in a shorter time than in the conventional case of using hot-melt resin, for example, thus making it possible to reduce manufacturing cost. In particular, the sheath covering portion 21 and the electrical wire through-hole portion 23 of the rubber plug 20 are clamped by the clamping rings 35 in a later step, thus making only low insertion force necessary for inserting the terminal 15A of the sheath 15 into the sheath covering portion 21 and inserting the electrical wires 11 into the through-holes 25L and 25S of the electrical wire through-hole portion 23, and ultimately making it possible to achieve close contact with high contact pressure, and to achieve improved seal functionality.

The sheath covering portion clamping ring 35A and the electrical wire through-hole portion clamping ring 35B are integrated with the bracket 30 for attachment to the vehicle, thereby reducing the number of components and also simplifying the operation of fitting the clamping rings 35A and 35B to the rubber plug 20 (sheath covering portion 21 and electrical wire through-hole portion 23).

In particular, this seal structure is constructed with use of the bracket 30 that specifies the attachment position of the terminal portion of the multiple-core cable 10, thus making it possible to achieve a more neatly organized multiple-core cable 10 routing structure.

The clamping rings 35 are formed with a C-shaped cross-section that includes the insertion groove 36 extending in the axial direction and is capable of elastic deformation in the diameter direction. For this reason, the clamping rings 35 can be fitted around the sheath covering portion 21 and the electrical wire through-hole portion 23 while the sheath covering portion 21 and the electrical wire through-hole portion 23 are inserted into the clamping rings 35 in the diameter direction through the insertion groove 36. In other words, the operation of fitting the clamping rings 35 can be performed easily.

### Other Embodiments

The technology disclosed in the present specification is not intended to be limited to the embodiment described using the above descriptions and drawings, and aspects such as the following are also encompassed in the technical scope.

The assembly procedure illustrated in the above embodiment is merely one example, and other procedures may be included, such as first attaching the bracket to the vehicle, then attaching the rubber plug to the terminal portion of the multiple-core cable, and then attaching the rubber plug to the clamping rings.

The sheath covering portion clamping member and the electrical wire through-hole portion clamping member may be provided as members that are separate from each other.

As one example in which the sheath covering portion clamping member and the electrical wire through-hole portion clamping member are provided integrally, a structure is possible in which a sheath covering portion clamping ring and an electrical wire through-hole portion clamping ring are formed on two end portions of a long and narrow tubular body that has a C-shaped cross-section.

The clamping members may be provided as members that are separate from the bracket.

The clamping members may have another structure, such as a structure in which a bolt is provided, and the clamping members are reduced in diameter by tightening the bolt.

The number of electrical wires arranged in the multiple-core cable is not limited to the four wires illustrated in the above embodiments, and any number of wires greater than or equal to two may be included.

Although the case of providing two types of electrical wires that have different outer diameters is illustrated in the above embodiment, three or more types of electrical wires may be provided, or only one type of electrical wire may be provided.

Examples of the sheathed electrical wires that constitute the electrical wires include an electrical wire in which the core wire is a stranded wire in which a plurality of metal strands are twisted together, and a so-called single core wire constituted by a metal bar member. Also, the electrical wires may be shielded electrical wires.

The multiple-core cable may be a cable in which the sheath is filled with a filling material.

The multiple-core cable may be a so-called cab tire cable, or may be a multiple-core shielded wire in which a plurality of electrical wires are enveloped by a shielding layer.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### List of Reference Numerals

10 Multiple-core cable

11 Electrical wire

11L First electrical wire

11S Second electrical wire

15 Sheath

15A Terminal (of sheath 15)

20 Rubber plug

21 Sheath covering portion

23 Electrical wire through-hole portion

25L First through-hole

25S Second through-hole

30 Bracket

35 Clamping ring (clamping member)

36 Insertion groove

1. A seal structure for a multiple-core cable, the seal structure comprising:
a multiple-core cable in which a plurality of electrical wires are enveloped by a sheath, and the plurality of electrical wires extend out from a terminal of the sheath;
a rubber plug provided with a sheath covering portion that is fitted around the terminal of the sheath, and an electrical wire through-hole portion that has a plurality of through-holes through which the electrical wires respectively pass; and
a clamping member that is attached to the sheath covering portion and the electrical wire through-hole portion of the rubber plug and can clamp the sheath covering portion and the electrical wire through-hole portion from an outer circumferential side,
wherein the clamping member has a sheath covering portion clamping member that is attached to the sheath covering portion, and an electrical wire through-hole portion clamping member that is attached to the electrical wire through-hole portion, and
the sheath covering portion clamping member and the electrical wire through-hole portion clamping member are provided integrally.

2. (canceled)

3. The seal structure for a multiple-core cable according to claim 1, wherein the clamping member is provided on a bracket for attachment to a vehicle.

4. The seal structure for a multiple-core cable according to claim 1, wherein the clamping member is formed by a C-shaped clamping ring that includes an insertion groove extending along the axial direction and that is capable of elastic deformation in a diameter direction.
